(19) United States
(12) Patent Application Publication
(10) Pub. No.: US 2011/0220616 A1
(43) Pub. Date: Sep. 15, 2011

(54) WELDING DEVICE WITH INTEGRAL USER INTERFACE

(75) Inventors: Peter Donald Mehn, Oshkosh, WI (US); Jeffrey G. Wells, Ontario (CA); Caleb Haven, Appleton, WI (US)

(73) Assignee: Illinois Tool Works Inc., Glenview, IL (US)

(21) Appl. No.: 13/019,444

(22) Filed: Feb. 2, 2011

Related U.S. Application Data
(60) Provisional application No. 61/312,533, filed on Mar. 10, 2010.

(51) Int. Cl. B23K 9/10; B23K 9/16

(52) U.S. Cl. 219/74; 219/130.1

(57) ABSTRACT

Welding torch assemblies including a torch body having a user interface module integrally formed therewith, a welding nozzle, and a torch lead assembly are provided. The user interface module may enable a user to control one or more parameters of a welding operation. The welding nozzle may be coupled to a first end of the torch body. The torch lead assembly may be coupled to a second end of the torch body opposite the first end and may include a weld power lead and a weld control lead.

### CROSS REFERENCE TO RELATED APPLICATIONS

This application is a Non-Provisional Patent Application of U.S. Provisional Patent Application No. 61/312,533, entitled “Remote User Interface”, filed Mar. 10, 2010, which is herein incorporated by reference.

### BACKGROUND

The invention relates generally to welding systems, and, more particularly, to welding devices with integral user interfaces for use in welding systems.

Welding is a process that has become increasingly ubiquitous in various industries and applications. While such processes may be automated in certain contexts, a large number of applications continue to exist for manual welding operations. Such welding operations rely on a variety of types of equipment to ensure the supply of welding consumables (e.g., wire feed, shielding gas, etc.) is provided to the weld in an appropriate amount at the desired time. For example, metal inert gas (MIG) welding typically relies on a wire feeder to ensure a proper wire feed reaches a welding torch. Such equipment typically includes one or more control panels, through which an operator may input the desired weld parameters, weld settings, and so forth, appropriate for the given welding operation.

Many existing welding systems include a control panel located on the welding power supply and an alternate control panel located on the wire feeder. However, the location in which the welding operation is performed may not be proximate to the welding power supply or the wire feeder, for example, in complex welding environments. In such instances, a welding operator may have to return to the welding power supply and/or to the wire feeder to change a desired weld setting or parameter during a welding operation. Such a feature of traditional systems may decrease productivity by necessitating stoppages in the welding operation. Accordingly, there exists a need for user interfaces that overcome such drawbacks.

### BRIEF DESCRIPTION

In an exemplary embodiment, a welding torch assembly includes a torch body and an interface module. The interface module includes a control panel adapted to enable a user to control one or more parameters of a welding operation and control circuitry coupled to the control panel and adapted to control operation of the control panel. The interface module is integrally assembled into the torch body. The welding torch assembly also includes an integral lead assembly having an interface lead adapted to transmit one or more of data and power to and/or from the control circuitry, a weld power lead adapted to supply weld power to a nozzle of the welding torch assembly, and a weld control lead adapted to transmit data to and/or from the torch body. The torch body, the interface module, and the integral lead assembly are assembled into an integral unit.

In another exemplary embodiment, a welding torch assembly includes a torch body including a user interface module integrally formed therewith and adapted to enable a user to control one or more parameters of a welding operation. The welding torch assembly also includes a welding nozzle coupled to a first end of the torch body. The welding torch assembly also includes a torch lead assembly coupled to a second end of the torch body opposite the first end and having a weld power lead and a weld control lead.

In a further embodiment, a welding system includes a welding power supply having power conversion circuitry adapted to receive primary power and to convert the primary power to a weld power output suitable for use in a welding operation. The welding system also includes a wire feeder coupled to the welding power supply via a first lead assembly and adapted to receive one or more of power, gas, and control signals from the welding power supply. The welding system also includes a welding torch assembly having a trigger, a user interface module, and a second lead assembly each integrally formed therewith. The second lead assembly includes a weld lead assembly and an interface lead assembly integrally formed as a single unit.

### DRAWINGS

These and other features, aspects, and advantages of the present invention will become better understood when the following detailed description is read with reference to the accompanying drawings in which like characters represent like parts throughout the drawings, wherein:

FIG. 1 illustrates an exemplary welding system that powers, controls, and provides supplies to a welding operation in accordance with aspects of the present invention;

FIG. 2 is a block diagram illustrating components of an exemplary welding power supply and an exemplary welding torch assembly in accordance with embodiments of the present invention;

FIG. 3 is a perspective view of an exemplary welding torch assembly including an integral user interface module in accordance with embodiments of the present invention;

FIG. 4 is a block diagram illustrating an embodiment of a method of manufacturing the integral torch assembly of FIG. 3 in accordance with aspects of the present invention;

FIG. 5 illustrates an embodiment of a user interface of an exemplary torch assembly including a graphical user interface and a shielding lens disposed over the user interface in accordance with embodiments of the present invention; and

FIG. 6 illustrates an alternate embodiment of a user interface of an exemplary torch assembly in accordance with embodiments of the present invention.

### DETAILED DESCRIPTION

As described in detail below, embodiments of welding torch assemblies including an integrally formed user interface module are provided. That is, in some embodiments, the user interface module may be integrated into the welding torch assemblies such that the interface module is necessary or essential for completeness of the welding torch assembly. In other words, certain embodiments of the welding torch assemblies may not be capable of functioning for use in a welding environment without the user interface module disposed therein. As such, in some embodiments, the user interface module may be configured for removal from the welding torch assembly, for example, for replacement or repair. However, in such embodiments, while the welding torch assembly is operational in a welding operation, the user interface module is integral with the assembly.

Further, in some embodiments, the welding torch assembly may also include a lead assembly integrally formed to include one or more weld conductors and one or more interface conductors. For example, the one or more weld conductors may include power leads, control leads, gas leads, wire leads, and so forth. For further example, the interface conductors may include one or more power leads, control leads, and so forth. Additionally, the lead assembly may be integrally formed with a body of the welding torch assembly that houses the user interface module. As such, embodiments of the present invention may provide integrally formed welding torch assemblies that include a torch body, a user interface module, and a lead assembly. Such embodiments may offer distinct advantages over traditional welding torch assemblies, which may not provide for integrally formed user interface modules at the location of the welding torch. For instance, the user interface module location in the welding torch may enable a welding operator to control one or more parameters of the welding operation at a location proximate to the weld. Such a feature may increase the ease of altering weld parameters during a weld operation by reducing the likelihood of an operator necessarily having to return to the welding power supply to change a weld parameter or setting.

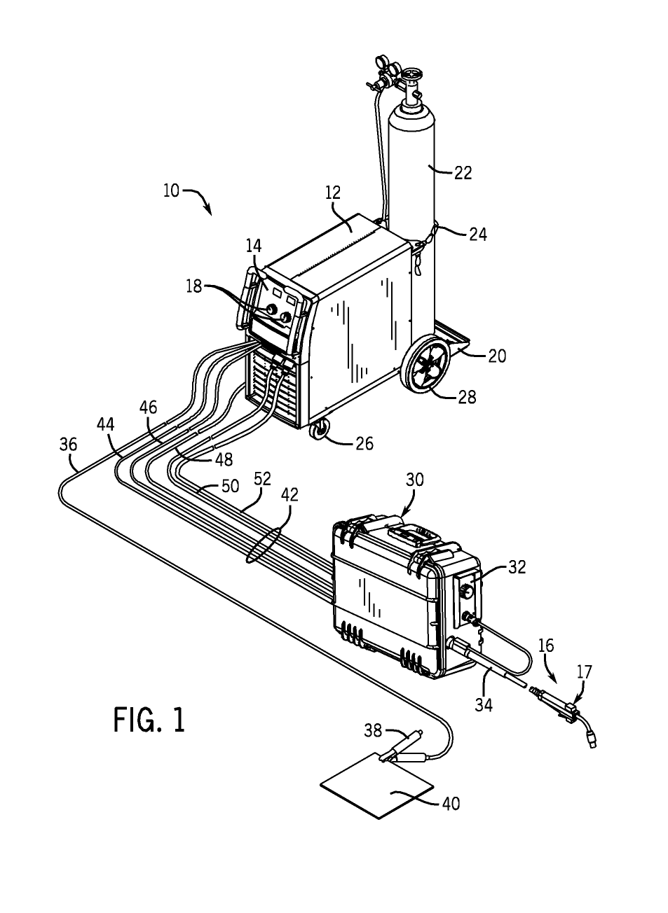

Turning now to the drawings, FIG. 1 illustrates an exemplary welding system 10 which powers, controls, and provides supplies to a welding operation. The welding system 10 includes a welder 12 having a control panel 14, through which a welding operator may control the supply of welding materials, such as gas flow, wire feed, and so forth, to a welding torch 16. In the illustrated embodiment, a user interface module 17 is integral with the welding torch 16. The control panel 14 located on the welder 12 includes input or interface devices, such as knobs 18, which the operator may use to adjust welding parameters (e.g., voltage, current, etc.). That is, the operator interface 14 on the welder 12 enables data settings to be selected by the operator. The operator interface 14 may allow for selection of settings such as the weld process, the type of wire to be used, voltage and current settings, and so forth. In particular, the system is designed to allow for MIG welding with aluminum or other welding wire that is both pushed towards the torch 16 and pulled through the torch 16.

In some embodiments, the user interface module 17 may include the same or different adjustments as compared to the control panel 14. As such, during a welding operation, the user interface module 17 integral with the welding torch 16 may enable the welding operator to control a feature or parameter of the welding operation without returning to the control panel 14 located on the welder 12. Further, in some embodiments, the welding system 10 may be programmed such that when the operator is controlling the welding operation via interface module 17, the control panel 14 is disabled, and when the operator controls the welding operation via control panel 14, the interface 17 is disabled. In such embodiments, the welding system 10 may be configured to lockout the control panel that is not in use such that only one control panel is active at any given time. Still further, in other embodiments, the welding system 10 may be programmed such that both the control panel 14 located on the welder 12 as well as the user interface module 17 located on the welding torch 16 may be activated at the same time.

In the illustrated embodiment, the welder 12 includes a tray 20 mounted on a back of the welder 12 and configured to support a gas cylinder 22 held in place with a chain 24. However, in other embodiments, the gas cylinder 22 may not be mounted on the welder 12 or may not be utilized in the welding system 10, for example, for gasless welding operations. In embodiments in which gas is desired for the welding operation, the gas cylinder 22 is the source of the gas that supplies the welding torch 16. Furthermore, the welder 12 may be portable via a set of smaller front wheels 26 and a set of larger back wheels 28, which enable the operator to move the welder 12 to the location of the weld or the welder 12 may be stationary as desired by the operator. Indeed, the illustrated welding system 10 is merely an example and may be modified as suitable for the type of welding operation being performed.

The illustrated welding system 10 also includes a suitcase wire feeder 30 that provides welding wire to the welding torch 16 for use in the welding operation. However, it should be noted that although the wire feeder 30 shown in the embodiment of FIG. 1 is a suitcase style feeder, in other embodiments, the wire feeder 30 may be any suitable wire feeder system, such as any of a variety of push-pull wire feeder systems, configured to utilize one or more motors to establish a wire feed to a welding torch. Indeed, embodiments of the present invention may be utilized in conjunction with motors of bench style feeders and/or non-bench style feeders, such as boom mounted style feeders and portable, suitcase-style wire feeders. Such wire feeders may be used with any wire feeding process, such as gas operations (gas metal arc welding (GMAW)) or gasless operations (shielded metal arc welding (SMAW)). For example, the wire feeders may be used in metal inert gas (MIG) welding or stick welding. Indeed, embodiments of the present invention include any suitable welding wire feeder.

The wire feeder 30 may include a control panel 32 that allows the user to set one or more wire feed parameters, such as wire feed speed. As before, the control panel 32 may include one or more control capabilities that are duplicated on the interface module 17 integral with the welding torch 16. That is, in some embodiments, parameters of the wire feed (e.g., rate of wire feed, wire diameter, etc.) may be controlled via control panel 32 and/or interface module 17. In certain embodiments, the control panel 32 and the interface module 17 may be configured for operation simultaneously or one at a time.

Additionally, the wire feeder 30 may house a variety of internal components, such as a wire spool, a wire feed drive system, a motor, and so forth. In some embodiments, the welding power received from the welder 12 may be utilized by the internal components of the wire feeder 30 to power the gas flow and wire feed operations if desired for the given welding operation. As such, the wire feeder 30 may be used with any wire feeding process, such as gas operations (gas metal arc welding (GMAW)) or gasless operations (shielded metal arc welding (SMAW)). For example, the wire feeder 30 may be used in metal inert gas (MIG) welding or stick welding. Still further, in welding operations that do not utilize a wire feed, the wire feeder 30 may not be utilized.

A variety of cables couple the components of the welding system 10 together and facilitate the supply of welding materials to the welding torch 16. A first lead assembly 34 couples the welding torch 16 to the wire feeder 30. As described in detail below, the first lead assembly 34 may include one or more integrated lead assemblies disposed therein. For example, in one embodiment, the lead assembly 34 may include an interface lead assembly that supplies power and/or control signals to and/or from the interface module 17 of the welding torch 16 as well as an integrated weld lead assembly that provides power, control signals, and welding consumables to the welding torch 16. That is, in some embodiments, the lead assembly 34 that is adapted to provide power, consumables, and controls to the components of the integral welding torch 16 is a single integrated unit.

A second cable 36 couples the welder 12 to a work clamp 38 that connects to a workpiece 40 to complete the circuit between the welder 12 and the welding torch 16 during a welding operation. A bundle 42 of cables couples the welder 12 to the wire feeder 30 and provides weld materials for use in the welding operation. The bundle 42 includes a feeder power lead 44, a weld cable 46, a gas hose 48, a weld control cable 50, and an interface control cable 52. Depending on the polarity of the welding process, the feeder power lead 44 may connect to the same weld terminal as the cable 36. It should be noted that the bundle 42 of cables may not be bundled together in some embodiments. Further, in certain embodiments, the interface control cable 52 may not be provided, and the control signals may be communicated between the interface module 17 and the welding power supply via control cable 50.

It should be noted that modifications to the exemplary welding system 10 of FIG. 1 may be made in accordance with aspects of the present invention. For example, the tray 20 may be eliminated from the welder 12, and the gas cylinder 22 may be located on an auxiliary support cart or in a location remote from the welding operation. Furthermore, although the illustrated embodiments are described in the context of a MIG welding process, the features of the invention may be utilized with a variety of other suitable welding systems and processes.

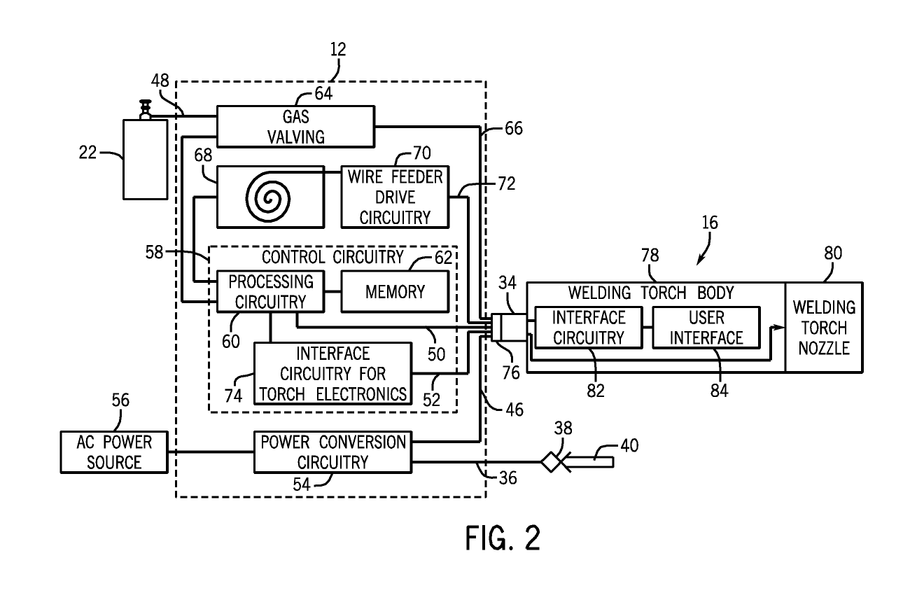

FIG. 2 is a block diagram illustrating exemplary components of the welding power supply 12 and the welding torch assembly 16. In the illustrated embodiment, the power supply 12 includes power conversion circuitry 54 that receives input power from an alternating current power source 54 (e.g., the AC power grid, an engine/generator set, a battery, or a combination thereof), conditions the input power, and provides output power via lead 46 to the cable 34 to power one or more welding devices (e.g., welding torch assembly 16) in accordance with demands of the system 10. Accordingly, in some embodiments, the power conversion circuitry 54 may include circuit elements, such as transformers, rectifiers, switches, and so forth, capable of converting the AC input power to a direct current electrode positive (DCEP) or direct current electrode negative (DCEN) output, as dictated by the demands of the system 10. The lead cable 36 terminating in the clamp 38 couples the power conversion circuitry 54 to the workpiece 40 and closes the circuit between the power source 12, the workpiece 40, and the welding torch 16.

The weld power supply 12 also includes control circuitry 58 that is configured to receive and process a plurality of inputs regarding the performance and demands of the system 10. The control circuitry 58 includes processing circuitry 60 and memory 62. The memory 62 may include volatile or non-volatile memory, such as ROM, RAM, magnetic storage memory, optical storage memory, or a combination thereof. Furthermore, a variety of control parameters may be stored in the memory 62 along with code configured to provide a specific output (e.g., initiate wire feed, enable gas flow, etc.) during operation. The processing circuitry 60 may also receive one or more inputs from the user interface 14 located on the power supply 12, through which the user may choose a process, and input desired parameters (e.g., voltages, currents, particular pulsed or non-pulsed welding regimes, and so forth).

Based on such inputs received from the operator, the control circuitry 58 operates to control generation of welding power output that is applied to the welding wire for carrying out the desired welding operation, for example, via control signals transmitted to the power conversion circuitry 54. Based on such control commands, the power conversion circuitry 54 is adapted to create the output power that will ultimately be applied to the welding wire at the torch 16. To this end, as noted above, various power conversion circuits may be employed, including choppers, boost circuitry, buck circuitry, inverters, converters, and so forth.

The power supply 12 may also be coupled to one or more gas tanks 22. The gas tank 22 may supply a shielding gas, such as argon, helium, carbon dioxide, and so forth, via hose 48. In the embodiment illustrated in FIG. 2, the gas enters gas valving 64 located in the power supply 12. The gas valving 64 communicates with the processing circuitry 60 to determine the quantity and flow rate of the gas to output via a gas conduit 66. Further, in the illustrated embodiment, the power supply 12 includes an integrated wire spool 68 and wire feeder drive circuitry 70 that cooperate with the processing circuitry 60 to provide a wire feed via cable 72.

Still further, in the embodiment of FIG. 2, the control circuitry 58 also includes interface circuitry 74 associated with the electronics of the torch assembly 16. The interface circuitry 74 is coupled to the processing circuitry 60 and to the torch assembly 16 via cable 52. Further, the processing circuitry 60 provides control signals associated with the weld operation to the welding torch 16 via cable 50. As such, the integral torch lead assembly 34 in the embodiment of FIG. 2 includes the gas conduit 66, the wire conduit 72, the data conduit 50, the data conduit 52, and the power conduit 46. As before, such conduits terminate at a single connection point 76 that couples to a single integral torch lead assembly 34.

The illustrated welding torch assembly 16 includes the torch lead assembly 34, a welding torch body 78, and a welding torch nozzle 80. The welding torch body 78 includes interface circuitry 82 and a user interface 84. During operation, the interface circuitry 82 of the welding torch assembly 16 communicates with the interface circuitry 74 located in the welder 12 via lead assembly 34 to coordinate operation of the welding power supply 12 and the torch assembly 16. As such, in the illustrated embodiment, a bidirectional data exchange path is established via lead assembly 34 between interface circuitry 74 in the welder 12 and interface circuitry 82 located in the torch assembly 16. However, it should be noted that in other embodiments, communication between components of the welding torch assembly (e.g., the user interface, the interface circuitry, etc.) and components of the welder 12 may occur via a wireless communication link. Still further, although in the illustrated embodiment, the welding torch electronics receive power via lead assembly 34, in other embodiments, a battery or other suitable energy storage device may be provided in the welding torch body 78 and utilized to power such electronics. In such embodiments, the weld power received by the torch body 78 via lead 34 may be utilized to recharge the energy storage device when the storage device is depleted.

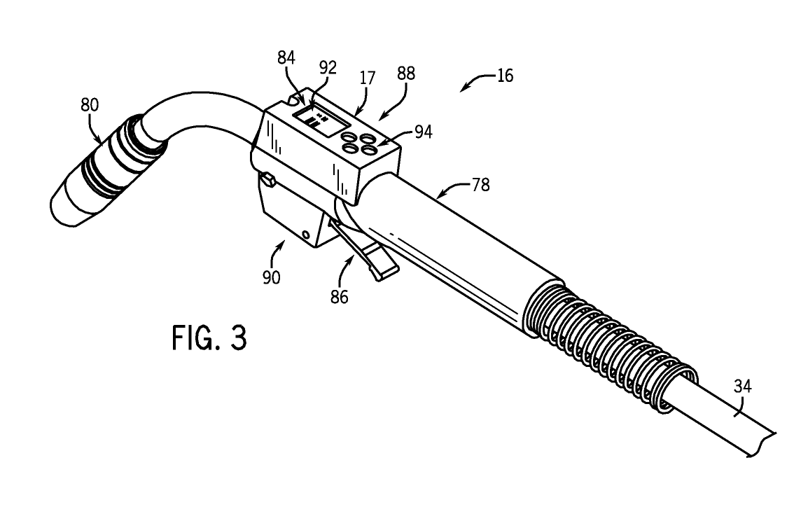

FIG. 3 is a perspective view of an exemplary welding torch assembly 16. In the illustrated embodiment, the welding torch assembly 16 includes the lead assembly 34, the torch body 78, and the torch nozzle 80. The torch body 78 includes the user interface module 17 disposed on a first side 88 of the body 78 and a trigger assembly 86 disposed on a second side 90 of the body 78 opposite the first side 88. In the illustrated embodiment, the user interface 84 includes a display 92 and a panel of controls 94. During operation, as the operator utilizes the panel of controls 94 to alter one or more parameters of the weld operation, the display 92 may indicate the changes to the user and/or may display the current weld parameters or settings.

It should be noted that in some embodiments, the user interface 84 may include controls that duplicate one or more controls on the control panel 14 of the welder 12 and/or one or more controls on the control panel 32 of the wire feeder 30. As such, in certain embodiments, the control circuitry 58 of the welder 12 may be configured to selectively activate or deactivate one or more of the control panels and interfaces 14, 32, and 84 or portions thereof. For example, in some embodiments, the control circuitry 58 may control the system such that when the operator is controlling the welding operation via interface 84, the control panel 14 and the interface 32 are disabled, and when the operator controls the welding operation via control panels 14 and 32, the interface 84 is disabled. In such embodiments, the welding system 10 may be configured to lockout the one or more control panels and/or interfaces that are not in use such that only the desired control panels are active at any given time. Still further, in other embodiments, the welding system may be operated such that the control panel 14 located on the welder 12, the user interface 84 of the torch, and the interface 32 on the wire feeder are all activated concurrently.

As shown, the torch assembly 16 is provided as a single integral unit. That is, as shown, embodiments of the welding torch assemblies disclosed herein include an integrally formed user interface module such that the interface module is necessary or essential for completeness of the welding torch assembly. As such, certain embodiments of the welding torch assemblies may not be capable of functioning for use in a welding environment without the user interface module disposed therein and the welding torch nozzle 80 attached thereto. However, it should be noted that certain embodiments may provide for the user interface module to be removed from the welding torch assembly, for example, for replacement or repair. Further, it should be noted that in some embodiments, if the integrally formed user interface is damaged and becomes unable to function during a welding operation, the welding operation may still be capable of being performed. To that end, in certain embodiments, the integral cable assembly 34 may include a lead assembly coupled to the gun trigger which is electrically isolated from a lead assembly coupled to the user interface. In such embodiments, because the circuitry associated with the gun trigger and the circuitry associated with the user interface are isolated from one another, damage to the user interface may not affect the performance of the welding torch in the welding operation.

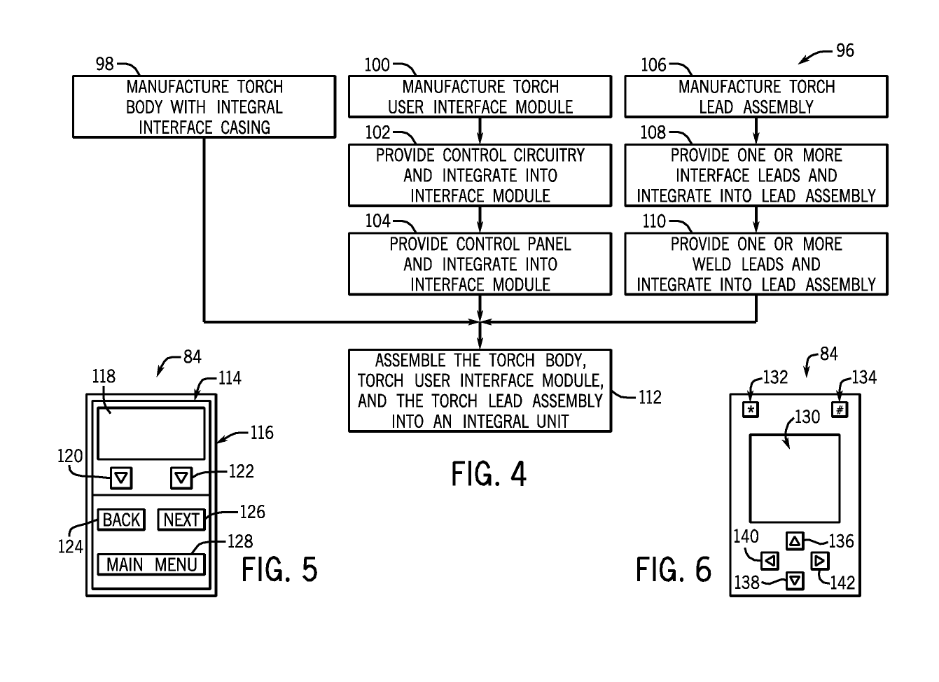

FIG. 4 illustrates an embodiment of a method 96 of manufacturing the integral torch assembly in accordance with aspects of the present invention. That is, the method 96 provides an example of how such an integral, single unit torch assembly with integrated control leads may be manufactured. Specifically, the method 96 includes manufacturing the torch body with an integral interface casing (block 98). The method 96 further includes manufacturing a torch user interface module (block 100), which is adapted to be received by the interface casing of the torch body during manufacture. Further, the method 96 includes providing the desired control circuitry and integrating such circuitry into the interface module (block 102). A control panel is also provided and integrated into the interface module (block 104).

Such a method 96 also includes manufacturing a torch lead assembly (block 106). One or more interface leads and one or more weld leads are further provided and integrated into the torch lead assembly (blocks 108 and 110). After each of the torch body, the torch user interface module, and the torch lead assembly are manufactured, such components are assembled into an integral unit (block 112). Again, each of the assembled components is necessary and essential for operational completeness of the torch lead assembly.

FIG. 5 illustrates an embodiment of the user interface 84 of the torch assembly 16 including a graphical user interface 114 and a lens 116 disposed over the user interface 84. The illustrated embodiment of the graphical user interface 114 includes interactive display 118, touch screen buttons 120 and 122, touch screen control buttons 124 and 126, and a touch screen main menu button 128. In the illustrated view, the user may press the back button 124 and the next button 126 to alternate between interactive screens as desired. Similarly, the user may press the main menu button 128 to return to a main selection menu that enables the user to select which weld parameter or setting is to be altered. However, the illustrated view is merely exemplary, and in other embodiments, any desired interactive touch screen interface may be employed.

The lens 116 may be configured to shield the graphical user interface 114 from one or more elements present in the welding environment. For example, in one embodiment, the lens 116 may be made of a material resistant to weld splatter. For further example, the lens 116 may be manufactured to resist high temperatures associated with welding environments. However, the shielding lens 116 may be transparent or partially transparent in some embodiments, such that the graphical user interface 114 is visible when the lens 116 is disposed thereon.

FIG. 6 illustrates an additional embodiment of the user interface 84 of the torch assembly 16 in accordance with aspects of the present invention. The user interface 84 includes a display 130, a quality monitoring button 132, a main menu button 134, an increase button 136, a decrease button 138, a back button 140, and a next button 142. During operation, the quality monitoring button 132 may be configured to illuminate to notify a user during weld quality monitoring. In such embodiments, the user may depress the button 132 to acknowledge that the notification is recognized. Further, the main menu button 134 may be depressed by the user to revert the display 130 back to a main selection menu. Still further, during use, the back and next buttons 140 and 142 may be utilized by the user to scroll between desired display screens. For example, the user may depress the next button 142 to switch the weld parameter displayed in the display 130 and configured to be increased or decreased via buttons 136 and 138.

While only certain features of the invention have been illustrated and described herein, many modifications and changes will occur to those skilled in the art. It is, therefore, to be understood that the appended claims are intended to cover all such modifications and changes as fall within the true spirit of the invention.

1. A welding torch assembly, comprising:
a torch body;
an interface module comprising a control panel configured to enable a user to control one or more parameters of a welding operation and control circuitry coupled to the control panel and configured to control operation of the control panel, wherein the interface module is integrally assembled into the torch body; and
an integral lead assembly comprising an interface lead configured to transmit one or more of data and power to and/or from the control circuitry, a weld power lead configured to supply weld power to the welding torch assembly, and a weld control lead configured to transmit data to and/or from the torch body, wherein the torch body, the interface module, and the integral lead assembly are assembled into an integral unit.

2. The welding torch assembly of claim 1, wherein the control panel comprises a graphical user interface configured to receive one or more desired weld inputs from an operator via a touch screen display.

3. The welding torch assembly of claim 1, wherein the interface module comprises a lens disposed over the control panel, wherein the lens comprises a weld splatter resistant material.

4. The welding torch assembly of claim 1, wherein the torch body comprises a first side comprising a torch trigger, and the interface module is coupled to the torch body on a second side of the torch body opposite the first side.

5. The welding torch assembly of claim 1, wherein the integral lead assembly further comprises a gas lead configured to provide a shielding gas to the nozzle of the welding torch assembly.

6. The welding torch assembly of claim 1, wherein the integral lead assembly further comprises a wire feed cable configured to provide wire to the nozzle of the welding torch assembly.

7. The welding torch assembly of claim 1, wherein when the interface module becomes damaged during a welding operation, the welding torch assembly is operable in the welding operation.

8. A welding torch assembly, comprising:
a torch body comprising a user interface module integrally formed therewith and configured to enable a user to control one or more parameters of a welding operation;
a welding nozzle coupled to a first end of the torch body; and
a torch lead assembly coupled to a second end of the torch body opposite the first end and comprising a weld power lead and a weld control lead.

9. The welding torch assembly of claim 8, wherein the torch lead assembly further comprises an integrally integrated interface lead assembly configured to provide power and/or control signals to the user interface module.

10. The welding torch assembly of claim 8, wherein the user interface module is configured to communicate with at least one of a welding power supply, a welding wire feeder, and an external control device via wireless communication.

11. The welding torch assembly of claim 8, wherein the torch body comprises a battery configured to provide power to the user interface module.

12. The welding torch assembly of claim 11, wherein the battery is configured to be recharged via power from the weld power lead of the torch lead assembly.

13. The welding torch assembly of claim 8, wherein the torch lead assembly further comprises a wire lead configured to deliver wire to the welding nozzle and a gas lead configured to deliver gas to the welding nozzle.

14. The welding torch assembly of claim 8, wherein the user interface module comprises a graphical user interface configured to enable an operator to control a parameter of the welding operation via a touch screen.

15. The welding torch assembly of claim 8, wherein the user interface module comprises a weld splatter resistant lens disposed over one or more weld controls.

16. A welding system, comprising:
a welding power supply comprising power conversion circuitry configured to receive primary power and to convert the primary power to a weld power output suitable for use in a welding operation;
a wire feeder coupled to the welding power supply via a first lead assembly and configured to receive one or more of power, gas, and control signals from the welding power supply; and
a welding torch assembly comprising a trigger, a user interface module, and a second lead assembly each integrally formed therewith, wherein the second lead assembly comprises a weld lead assembly and an interface lead assembly integrally formed as a single unit.

17. The welding system of claim 16, wherein the user interface module is configured to bidirectionally communicate with the welding power supply via the first lead assembly and the second lead assembly.

18. The welding system of claim 16, wherein the user interface module is configured to communicate with at least one of a welding helmet, an arc data monitoring system, and a fume extractor via wireless communication.

19. The welding system of claim 16, wherein the user interface module is configured to receive power from the weld lead assembly of the second lead assembly.

20. The welding system of claim 16, wherein the user interface module and the trigger are disposed on opposite surfaces of a body of the welding torch assembly.
